(19) United States
(12) Patent Application Publication
(10) Pub. No.: US 2013/0054458 A1
(43) Pub. Date: Feb. 28, 2013

(54) Money Transfer Utilizing a Social Network Environment

(71) Applicants: Ryan T. Jandris, Cannon Falls, MN (US); Anton B. Luttig, Pretoria (ZA)

(72) Inventors: Ryan T. Jandris, Cannon Falls, MN (US); Anton B. Luttig, Pretoria (ZA)

(73) Assignee: Moneygram International, Inc., Minneapolis, MN (US)

(21) Appl. No.: 13/216,801

(22) Filed: Aug. 24, 2011

(51) Int. Cl. G06Q 40/00

(52) U.S. Cl. 705/44

(57) ABSTRACT

Systems and methods which utilize a social media platform to provide authentication information for a money transfer transaction are provided. Embodiments may include obtaining and utilizing information from online social network profile data of the sender, receiver or both in order to facilitate a convenient and secure transaction. Embodiments include an online social network profile database configured to store and correlate profile information for multiple users and a money transfer transaction processing device in communication with the database to authenticate a money transfer transaction. Embodiments may be implemented on the internet, with dedicated applications for a computer and/or mobile device, and the like.

### TECHNICAL FIELD

The present application relates to money transfer transactions, and more specifically to systems and methods for authenticating money transfer transactions.

### BACKGROUND

In a money transfer transaction it is important to be able to authenticate the parties of the transaction. In some instances authentication comes in the form of a generated writing or receipt which includes a transaction number. This transaction number is given to the sender whereby the sender may provide it to a receiver, usually by email, phone and the like. Thereafter, the receiver provides this number to an agent at a money transfer agent location as part of the receiving process.

Other information utilized in authentication procedures may include a security question and answer used on the receiving end of a transaction. With such procedures, at the time the send transaction is established, a sender can specify if they want to use question/answer functionality. Users may select pre-generated questions or type their own questions and then specify the correct answer. The receiver of the money transfer then provides the correct answer to an agent on the receiving end in order to assist in authenticating the transaction.

While these methods are widely used in money transfer transactions, it is noted that the methods are not necessarily ideal. When establishing authentication procedures, a money transfer service provider may desire to balance the need for a quick customer transaction to allow for a quality transaction experience, with the need to add additional levels of security in a transaction. For example, when utilizing a security question and answer procedure, customers and money transfer businesses may find the transaction process cumbersome as it requires additional agent/customer interaction. However, the additional security that such a process brings to a transaction may be seen as sufficiently beneficial to justify the cumbersome nature of the extra authentication steps.

### SUMMARY

The present application provides for systems and methods which utilize a social media platform to provide authentication information for a money transfer transaction. Embodiments may obtain and utilize information from profile data of the sender, receiver or both in order to facilitate a convenient and secure transaction. Embodiments may be implemented on the interne, with dedicated applications for a computer and/or mobile device, and the like.

An example embodiment may be characterized as a method for facilitating a money transfer transaction which includes collecting transaction information from a sender, including an amount and destination information. In addition, the method includes collecting authentication information from the sender, including information derived from the sender's online social network profile. Further, the method includes accepting funds from the sender and generating the money transfer transaction.

Another example embodiment may be characterized as a method for facilitating a money transfer transaction which includes collecting information from a receiving party, including information obtained from the receiving party's social network profile. The method also includes utilizing, in part, information obtained from the receiving party's social network profile to authenticate the receiving party as the target party of a previously generated money transfer transaction. After the receiving party is successfully authenticated, the method includes providing payment to the receiving party to complete the money transfer transaction.

An additional embodiment of the invention includes a system with an online social network profile database which is configured to store and correlate profile information for multiple users. The system also includes a money transfer transaction processing device in communication with the online social network profile database, where the processing device is configured to utilize information derived from the online social network profile database to authenticate a money transfer transaction.

### BRIEF DESCRIPTION OF THE DRAWINGS

For a more complete understanding of the present invention, reference is now made to the following descriptions taken in conjunction with the accompanying drawings, in which:

FIG. 1 illustrates a system for facilitating money transfer transactions in accordance with an embodiment of the present application;

FIG. 2 illustrates a flowchart of a method for facilitating a money transfer transaction in accordance with an embodiment of the present application; and

FIG. 3 illustrates a flowchart of another method for facilitating a money transfer transaction in accordance with an embodiment of the present application.

### DETAILED DESCRIPTION

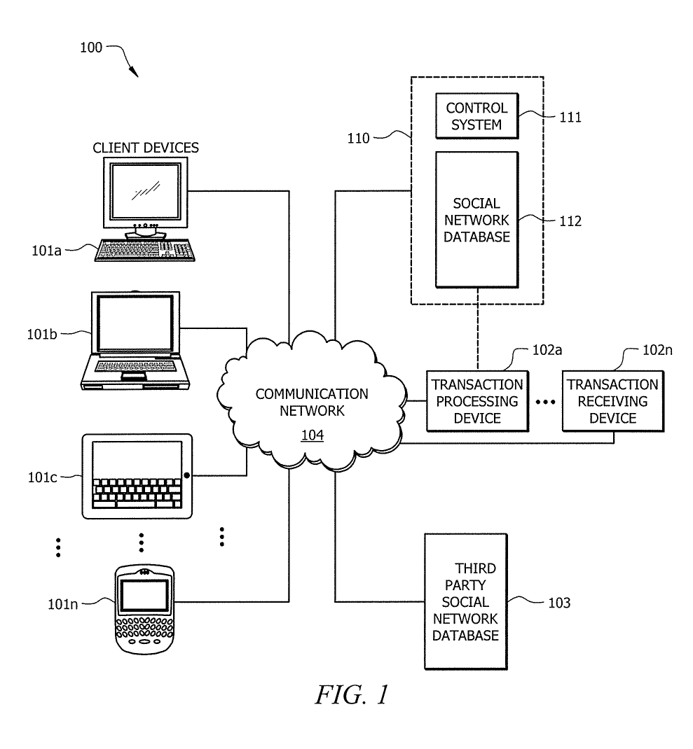

FIG. 1 illustrates a system 100 for facilitating money transfer transactions in accordance with an embodiment of the present application. System 100 includes a money transfer service online network 110. Network 110 includes control system 111 and social network database 112. Control system 111 is configured to control the flow of information to and from social network database 112. Such information may include information between client devices 101a-101n and between transaction processing devices 102a-102n. Further, control system 111 may be used to control interaction with third party social network utilities such as third party social network database 103. Control system 111 may also be used to distribute and manage social network applications between client devices 101a-101n, social network database 112, third party social network database 103, etc.

Communications between devices in system 100 may be facilitated in whole, or in part, by communication network 104. Communication network 104 may comprise the Internet, WiFi, mobile communications networks such as GSM, CDMA, 3G/4G, WiMax, LTE, and the like. Further, communications network 104 may comprise a combination of network types working collectively.

Transaction processing devices 102a-102n may correspond to computer systems within a money transfer agent location. Such devices may be computer systems which are accessible by an agent, or may be automated machines such as an Automated Teller Machine (ATM). Transaction processing devices may be located throughout the world and one or more devices may be utilized within a single money transfer transaction. Transaction processing devices 102a-102n are configured to send and receive information over communication network 104. In some embodiments, transaction processing devices 102a-102n may also have a direct connection with money transfer service online network 110. Transmitted information may be transaction and authentication information for a new money transfer transaction or for an existing transaction. Further, as discussed below, transaction processing devices 102a-102n may exchange information directly with client devices 101a-101n.

Client devices 101a-101n may be any type of device which would facilitate the exchange of information with a social network database. For example, client devices may include computer systems, tablet devices, mobile telephones, and the like. Different embodiments may utilize different aspects of the types of client devices. For example, mobile telephones and tablet devices may have the ability to connect with various communications networks, may include location functionalities such as a Global Positioning System (GPS), and may have different application execution capabilities. Client devices 101a-101n may be utilized before, during and after a money transfer transaction in any manner to facilitate convenient and secure transactions.

In one embodiment, social network database 112 is configured to collect and organize user profile data. User profile data may include any data about a user including personal information, contact information, photographs, information regarding mobile devices belonging to the user, and information regarding social contacts within social network database 112, and the like. In this manner a user may establish relationships and connections in an online community administered by social network database 112 and control system 111.

Profile data may then be utilized in money transfer transactions. Money transfer transactions include a sending party and a receiving party. In money transfer transactions it is helpful to know if the sender and receiver have an established relationship for security purposes. For example, when two parties have implemented multiple money transfer transactions, a money transfer service agent may be more confident that the transaction is legitimate. In this manner, where profile data is established on social network database 112, a money transfer service agent is given additional information to ensure the security of the transaction. In some instances the sending party and receiving party may both have profiles in the online community and may even have an established relationship connection. In other instances, only one party of a transaction may have a usable social network profile. In any case, the additional information obtained from the profile data assists a money transfer agent in authenticating a transaction.

For example, in a transaction involving a sending party and a receiving party who both have profile data and an established relationship connection, such a connection may be utilized as evidence that the transaction is legitimate. Further, in some instances the sender may be brought into the authentication procedure where the sender may be asked a question about the receiver at the time of generating the transaction or at the time of receipt of the funds. For example, when a receiver is picking up the funds at a particular location, the sender may be asked if that location is connected to the receiver.

Information regarding the transaction, e.g. the existence of the transaction, amount, etc., may also be sent to the receiver over the social network connection. In this manner, positive customer experiences are facilitated while security in communications may be monitored by the money transfer service agent.

In the event that only one party (either sender or receiver) has profile data available, knowledge of that party may still be utilized in insuring that the transaction is legitimate. For example, knowledge of where a person lives or frequently travels may assist in recognizing an anomaly in a transaction when that person is sending or receiving money in a different geographical area. Likewise, such knowledge can serve to show that a transaction is proper when the person is in a known area for that individual.

Another example of utilizing profile data for authentication may come where an agent on the receive side of the transaction is provided a picture of the receiving party. Such a picture may be provided with profile information of the sender or receiver. In this example, the agent would be able to authenticate the identification of the receiving party by comparing the received photograph with the person present at the agent location. A further example of utilizing profile data for authentication is where an agent on the receive side of the transaction is provided information about the receiving party, such as the relationship to the sender, or information regarding hobbies, experiences or other such information as may be present on the receiver's profile.

Profile data may also be used to track other regulatory matters which are pertinent to money transfer transactions. For example, with the collection of profile data and knowledge of social connections, the information may be used to comply with Office of Foreign Asset Control regulations and anti-laundering regulations, to insure that the parties are not on a terror watch list, and the like.

In one embodiment, a social network application is distributed to one or more client devices 101a-101n to facilitate sharing information and making connections with others utilizing social network database 112. Such an application may include an Android™ or iPhone™ application configured to execute on a mobile device. In these embodiments, mobile device information may be utilized as part of a user's profile, e.g. the type of device, the location of the device, etc. Such information may be utilized in authenticating or even initiating and completing a money transfer transaction. For example, embodiments may utilize location data of a mobile device to authenticate that the actual user is in a particular area or near an agent location. Such data may be retrieved using GPS data from a mobile device that is communicated over communications network to money transfer service online network 110 or to a transaction processing device 102a-102n at an agent location. Further, other methods of retrieval may be utilized such as near frequency communications between a mobile device 101 and a transaction processing device 102a-102n.

In some embodiments, proximity information with respect to an agent location may be utilized to initiate portions of a transaction. For example, when a sender is near or enters an agent location, transaction processing device 102a-102n may begin to initiate and gather information for a send transaction in order to expedite the transaction procedure. Additionally, when a receiving party nears an agent location, transaction processing device 102a-102n may identify the user, find the appropriate transaction, and begin receiving procedures for a transaction.

In some embodiments, profile data may be managed and collected on third party social network database 103, or shared between social network database 112 and third party social network database 112. Third party social network database may correspond to a third party social network community such as Facebook™, LinkedIn™, MySpace™, Twitter™, Windows Live™, and the like. In some embodiments, a social network application, such as discussed above, may be implemented within the confines of the third party service, e.g. a Facebook™ application, while social network database 112 obtains information from the third party database 103 according to pre-specified procedures. It is contemplated that any functionality of social network database 112 and third party database 103 may be distributed between these devices and access to each may be controlled by control system 111.

In one embodiment, the authentication capabilities discussed herein may be utilized by third parties. For example, online communities often have internal currencies such as Facebook™ Credits. If a user is attempting to transfer such currencies to another user within the community, embodiments may utilize authentication services of money transfer service online network 110 to assist in party identification, compliance with government requirements, etc., for these transfer transactions. Embodiments may also extend these authentication capabilities into other types of communities which utilize currency, such as online gaming communities, e.g. World of Warcraft™, Second Life™, and the like.

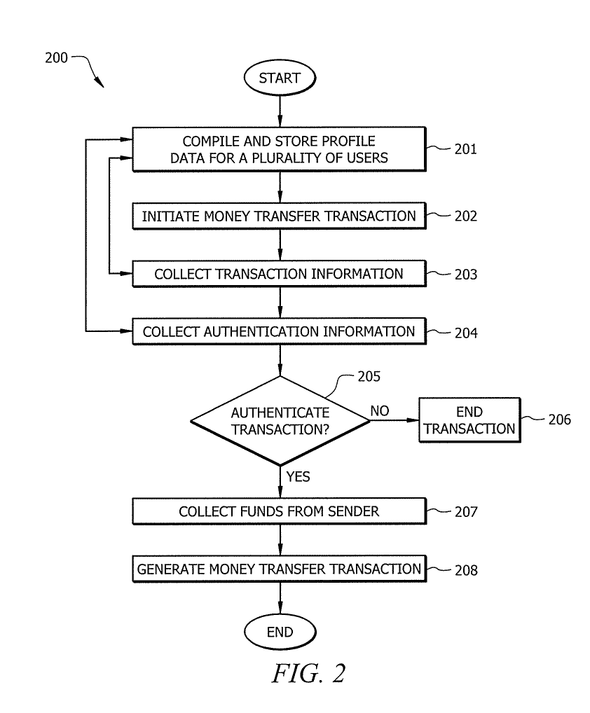

FIG. 2 illustrates a flowchart of a method 200 for facilitating a money transfer transaction in accordance with an embodiment of the present application. Method 200 may be implemented within a system such as system 100 or any other suitable system. Additionally, while method 200 is set forth in steps, it is noted that nothing in this application necessarily limits the order in which the illustrated steps are implemented. In fact, some steps may be implemented in different orders, simultaneously, at multiple points in time, or not at all.

Method 200 begins by compiling profile data for a plurality of users 201. As discussed above, profile data may include personal information, information about online connections, information about shared attributes between connections, location information, etc. In some embodiments, profile information includes information regarding people or places that previous money transfer transactions have been implemented.

A money transfer transaction begins with a sender initiating the transfer transaction 202. Such an initiation may be implemented by a user entering an agent location and beginning the process, by a user accessing an ATM system belonging to an agent, etc. Further, as discussed above, a transaction may be initiated in whole or in part by a money transfer application executing on a mobile device of a user when the user is proximate to an agent location.

Transaction information is collected at step 203. Transaction information may include, for example, information regarding the transaction amount and destination/receiver information. Transaction information may be collected directly from the sender, or may be collected from application data or data stored with the sender's profile. Further, transaction information may be compiled from both the user and application/stored data.

Authentication information is also collected at step 204. Authentication information may include, social networks in which the receiver and/or sender participate. As with transaction information, authentication information may be collected directly from the sender, or may be collected from application data or data stored with the sender's or receiver's profile in the social network. Further, transaction information may be compiled from both the user and application/stored data.

At step 205, the method 200 may implement an authentication step to authenticate the transaction. Such authentication may include information needed to check the sender or receiver for any governmental restrictions. Further, such an authentication step may be included to insure any type of additional transaction compliance which may be desired by a money transfer agent, to verify the source of funds from the sender, and the like. In the event that authentication fails, the transaction is ended 206. Otherwise, the transaction may continue and funds may be collected from the sender at step 207.

With all the required information and the funds, the money transfer transaction is generated at step 208. Once the transaction is generated, a sender may inform a receiver of the transaction. Alternatively, in some embodiments, such a notification may be automatically implemented with a money transfer application as discussed above.

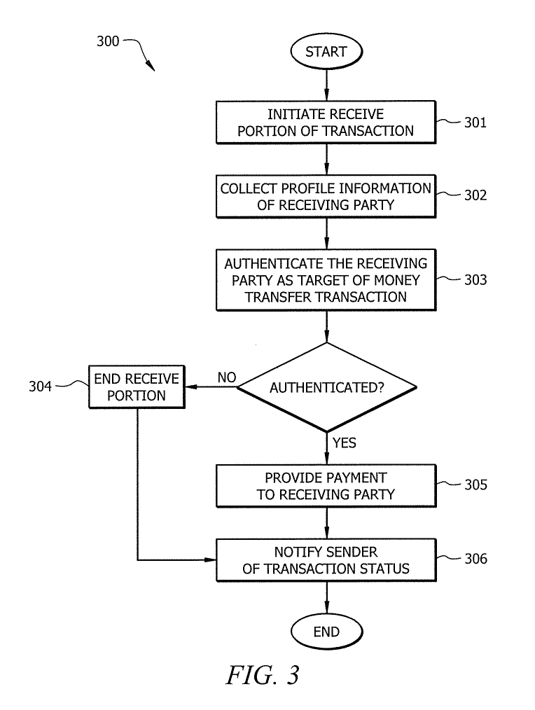

FIG. 3 illustrates a flowchart of a method 300 for facilitating a money transfer transaction in accordance with an embodiment of the present application. As was the case with respect to the flowchart of FIG. 2, method 300 may be implemented within a system such as system 100 or any other suitable system. Additionally, while method 300 is set forth in steps, it is noted that nothing in this application necessarily limits the order in which the illustrated steps are implemented. In fact, some steps may be implemented in different order, simultaneously, at multiple points in time, or not at all.

Method 300 begins with the initiation of a receive portion of a money transfer transaction 301. Such an initiation may be made by the receiving party entering an agent location, accessing an ATM machine, initiating contact using a money transfer application, etc. At step 302, profile information of the receiving party is collected by a transaction processing device. As discussed above, profile information may include personal information, location information, photographs, information regarding the receiving party's relationship with the sender, etc.

At step 303, the receiving party is authenticated as the target of the money transfer transaction using, at least in part, the collected profile information. It is noted that the authentication does not have to exclusively utilize profile information. In some embodiments, multiple methods may be utilized to authenticate the receiving party, e.g. security questions, possession of a transaction identification number, etc. Additionally, embodiments may ask the receiving party to answer one or more questions based on the sender's and/or receiver's profile data. If the authentication fails, the receive portion of the transaction is ended 304. Alternatively, if the authentication is successful, payment is provided to the receiving party 305.

Upon completing the transaction, method 300 may include step 306 which notifies the sender of the transaction status. This notification may be made using a money transfer social network application, or may be made by any other means which can efficiently convey the status information.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for facilitating a money transfer transaction, the method comprising:
collecting, by a processing device of a money transfer service, transaction information from a sender, the transaction information including a transaction amount and transaction destination information;
collecting, by the processing device of said money transfer service, profile information derived from an online social network profile belonging to the sender;
using the collected profile information to authenticate the propriety of the money transfer transaction;
accepting funds from the sender; and
generating the money transfer transaction.

2. The method of claim 1 further comprising collecting at least one of transaction information or profile information from a mobile device application.

3. The method of claim 2 wherein upon a mobile device coming near a money transfer agent location, said method further comprises:
automatically receiving, by the processing device of said money transfer service, the profile information; and
authenticating the sender, based at least in part on the automatically received profile information.

4. The method of claim 3 wherein the mobile application has access to Global Positioning System (GPS) information from the mobile device.

5. The method of claim 1 further comprising:
collecting information from a receiver;
comparing said information to the profile information; and
completing the transfer transaction upon obtaining a successful authentication.

6. The method of claim 5 wherein the receiver does not have an online social network profile.

7. The method of claim 5 wherein the receiver has an online social network profile and profile information for the transaction is provided via the receiver's online social network profile.

8. The method of claim 1 wherein profile information includes at least one of: information about the sender regarding previous transactions, information about the sender's connection with a receiving party, and location information of at least one of the sender and receiver.

9. The method of claim 1 wherein transaction information includes information relating to the amount and destination of the transaction.

10. The method of claim 9 wherein transaction information is collected, via an application accessing the social network.

11. A method for facilitating a money transfer transaction, the method comprising:
collecting information from a receiving party of a money transfer transaction, wherein the collected information includes information obtained from a social network profile for the receiving party;
authenticating a previously generated money transfer transaction utilizing, in part, the information obtained from the social network profile of the receiving party; and
upon successful authentication, providing payment to the receiving party to complete the money transfer transaction.

12. The method of claim 11 wherein the sender is not part of the social network.

13. The method of claim 11 wherein the sender has a profile on the social network.

14. The method of claim 13 wherein the sender utilizes the social network information to establish, at least in part, the collected information used for authentication.

15. The method of claim 11 wherein the receiver is notified of the transaction via the social network.

16. The method of claim 11 wherein the receiver initiates the receiving portion of the transaction via an application accessing the social network.

17. The method of claim 16 wherein the application resides on a mobile device.

18. The method of claim 17 wherein the application automatically communicates information to be sent to a money transfer agent location when the receiving party is proximate to the agent location.

19. A system comprising:
an online social network profile database configured to store and correlate profile information for a plurality of users;
a money transfer transaction processing device in communication with the online social network profile database, wherein the money transfer transaction processing device is configured to utilize information derived from the online social network profile database to authenticate a money transfer transaction.

20. The system of claim 19 wherein the money transfer transaction processing device is configured to utilize information derived from the online social network profile database to obtain transaction information for a money transfer transaction.

21. The system of claim 19 further comprising a plurality of client devices configured to communicate with the online social network profile database and to provide profile information for one or more users.

22. The system of claim 21 wherein at least one of said plurality of client devices is further configured to communicate with the money transfer transaction processing device.

23. The system of claim 22 wherein the at least one client device is configured to provide at least one of transaction information and authentication information to the money transfer processing device.

24. The system of claim 23 wherein transaction information includes information relating to the amount and destination of the transaction.

25. The system of claim 23 wherein authentication information includes at least one of: information about the sender regarding previous transactions, information about the sender's connection with a receiving party, and location information of at least one of the sender and receiver.

26. The system of claim 21 wherein the online social network database is configured to exchange information with one or more additional social network databases.
